(19) United States
(12) Patent Application Publication
(10) Pub. No.: US 2015/0185406 A1
(43) Pub. Date: Jul. 2, 2015

(54) Light Guide Element and Optical Device Comprised Thereof

(71) Applicant: Wistron Corporation, New Taipei City (TW)

(72) Inventors: Chien-An CHEN, New Taipei City (TW); Chen-Wei HUANG, New Taipei City (TW)

(21) Appl. No.: 14/299,858

(22) Filed: Jun. 9, 2014

(30) Foreign Application Priority Data
Dec. 27, 2013 (TW) 102224653

(51) Int. Cl. F21V 8/00

(52) U.S. Cl. CPC G02B 6/0081; G02B 6/0073; G02B 6/0045; G02B 6/0021

(57) ABSTRACT

The invention relates to a light guide element and an optical device comprised thereof. The optical device includes a substrate, a light emitting element, a lid body, a light guide element, a support pad, and an indicator panel. The light emitting element is disposed on the substrate. The lid body is coupled to the substrate and contains a receiving groove on the surface. The light guide element is coupled to the inner side of the lid body and is substantially disposed above the light emitting element. The underside of the support pad is affixed to the receiving groove. The underside of the indicator panel is affixed to the surface of the support pad whereas the indicator panel includes a photic zone where light, emitted from the light emitting element and guided by the light guide element, passes through.

### BACKGROUND OF THE INVENTION

1. Field of the Invention

The present invention relates to a light guide element and an optical device comprised thereof, especially a light guide element, which can increase the uniformity and brightness of the light, and an optical device comprised thereof.

2. Description of the Prior Art

In the design of a personal computer, a server, a mobile phone or other electronic devices, in order to allow users to operate the electronic device more conveniently in a dim room or an area lack of light, the case of the electronic device is mostly equipped with a light emitting function. Usually, a light source, such as a light emitting diode, is housed on a substrate and light is then transmitted to the case through a light guide element. When light passes through the case, digits or figures on the surface of the case can be revealed in aid of the user's operation.

An ideal light emitting device has a light source which has less scattering loss during penetration, stronger emission intensity with extremely high uniformity, in order to achieve the goal of having uniform light and to avoid localized bright spots. To achieve these features, the active search of innovative designs of light guide elements and optical devices has become an immediate and important issue to be realized in the industry.

Therefore, there is a need to invent a light guide element and an optical device comprised thereof to solve the shortfall of previous technology.

### SUMMARY OF THE INVENTION

The main objective of the present invention is to provide to a light guide element, which can enhance the effect of uniformity and brightness of the light.

The other main objective of the present invention is to provide an optical device comprised of the aforementioned light guide element.

To achieve aforementioned objectives, the light guide element of the present invention is used to guide light of the light emitting element to coming through from the lid body. The light guide element comprises a lower side structure, an upper side structure and a central structure. The lower side structure extends toward the light emitting element. The bottom portion of the lower side structure includes an incoming light surface which is adjacent to the light emitting element. The upper side structure comprises an outgoing light surface which is adjacent to the lid body. The central structure is positioned between the upper side structure and the lower side structure. The central structure comprises two combining parts extending to both sides of the upper side structure separately. These two combining parts include connecting holes separately. The light guide element is joined to the lid body by means of the connecting hole.

The optical device comprised of the light guide element of the present invention includes a substrate, a light emitting element, a lid body, a light guide element, a support pad, and an indicator panel. The light emitting element is disposed on the substrate. The lid body is coupled to the substrate and contains a receiving groove on the surface. The light guide element is coupled to the inner side of the lid body and is essentially disposed above the light emitting element. The underside of the support pad is affixed to the receiving groove. The underside of the indicator panel is affixed to the surface of the support pad whereas the indicator panel includes a photic zone where the light, emitted from the light emitting element and guided by the light guide element, passes through.

Since the present invention contains an innovative design structure, can be implemented for industrial use, and can increase effectiveness, thus the patent application of the present invention is submitted according to the patent laws.

### BRIEF DESCRIPTION OF THE DRAWINGS

FIG. 1 is a schematic exploded view of an embodiment of the optical device of the present invention.

FIG. 2 is a cross-sectional side view of an embodiment of the optical device of the present invention.

FIG. 3A is a schematic diagram of an embodiment of the light guide element of the present invention.

FIG. 3B is a schematic bottom view of an embodiment of the light guide element of the present invention.

### DETAILED DESCRIPTION OF THE PREFERRED EMBODIMENT

The aforementioned and other objectives, characteristics and advantages of the present invention will become more fully understood from the detailed description given herein below by way of embodiments with reference to the accompanying drawings for illustration only. Thus, the description does not limit the present invention.

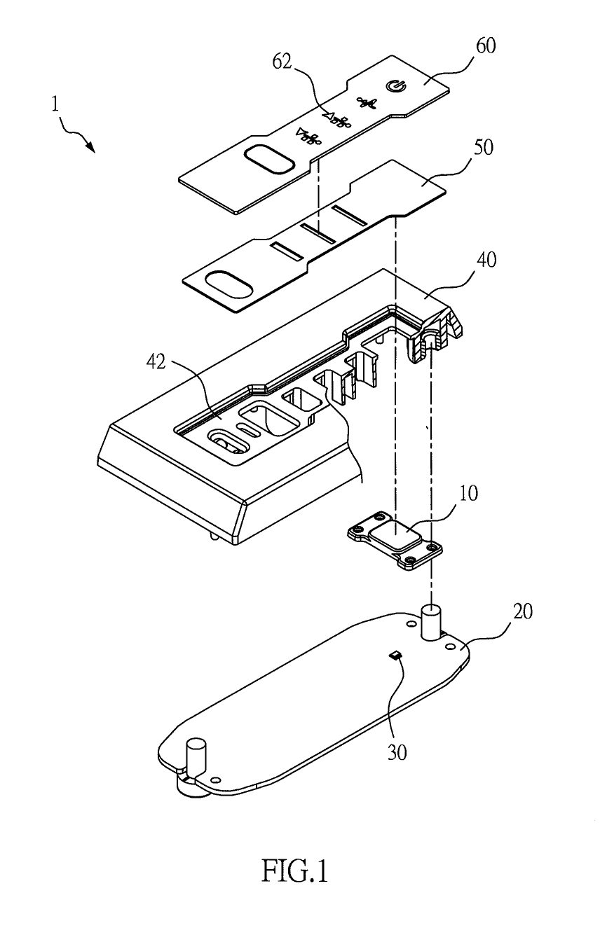

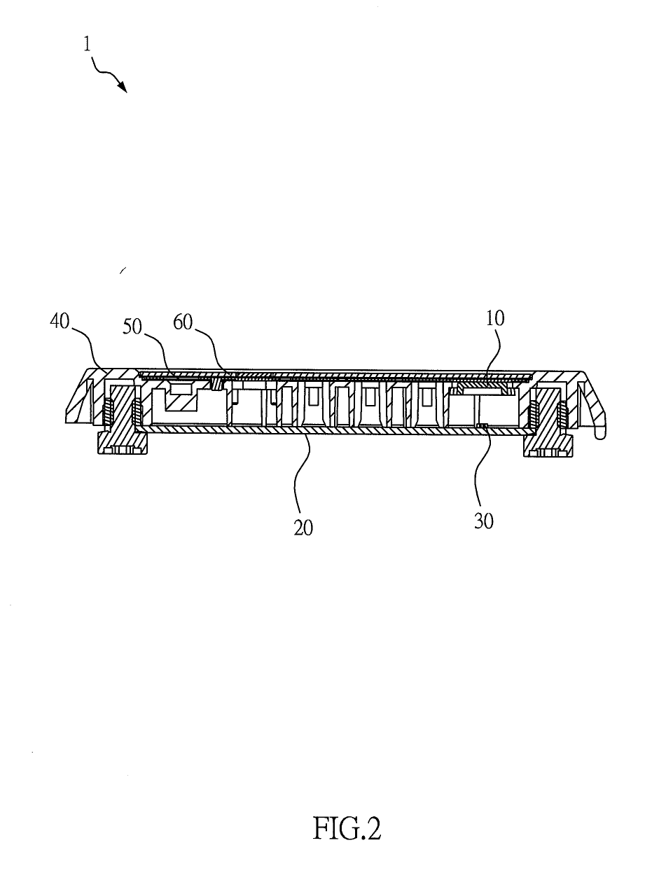

With reference to FIG. 1 and FIG. 2, FIG. 1 is a schematic exploded view of an embodiment of the optical device of the present invention; FIG. 2 is a cross-sectional side view of an embodiment of the optical device of the present invention.

According to one embodiment of the present invention, as illustrated in FIG. 1 and FIG. 2, the optical device includes a light guide element 10, a substrate 20, a light emitting element 30, a lid body 40, a support pad 50, and an indicator panel 60. Guided by the light guide element 10, light of the light emitting element 30, can extend across the entire lid body 40 and pass through the indicator panel 60.

According to one embodiment of the present invention, the substrate 20 is a printed circuit board. Both ends of the substrate 20 can be attached to the lid body 40 through screws. The light emitting element 30 is disposed on the substrate 20 and is preferably, for example, a vertical light emitting diode having light emitted mostly in a vertical upward direction. The light guide element 10 can be coupled to the inside of the lid body 40 using the snap-lock method and essentially positioned above the light emitting element 30. Namely, light of the light emitting element 30 can be guided by the light guide element 10 to enter the bottom of the light guide element 10 and to exit from the top of the light guide element 10.

According to one embodiment of the present invention, the lid body 40 is a closed cover body and, once it is combined with the substrate 20, encloses the light emitting element 30 therein. Inside the lid body 40, combining bolts and other components can be installed in order to fixedly mount the light guide element 10 therein. The surface of the lid body 40 has a receiving groove 42 available for placing the indicator panel 60 and the support pad 50. The support pad 50 can be made of photic material such as rubber and is affixed to the receiving groove 42 of the lid body 40 with the use of clear glue on the bottom surface of the support pad. According to one embodiment of the present invention, the center of the support pad 50 can be hollow to enhance the effect of light penetration. The indicator panel 60 is disposed on top of the support pad 50 and can be affixed to the support pad 50 also with the use of clear glue on the bottom surface of the indicator panel. The indicator panel 60 includes at least one photic zone 62. The shape of the photic zone 62 can be circular, polygonal, or irregular as the graphical pattern for displaying functions. Guided by the light guide element 10, light of the light emitting element 30 can pass through the photic zone 62 in order to increase the identifiability of the corresponding function.

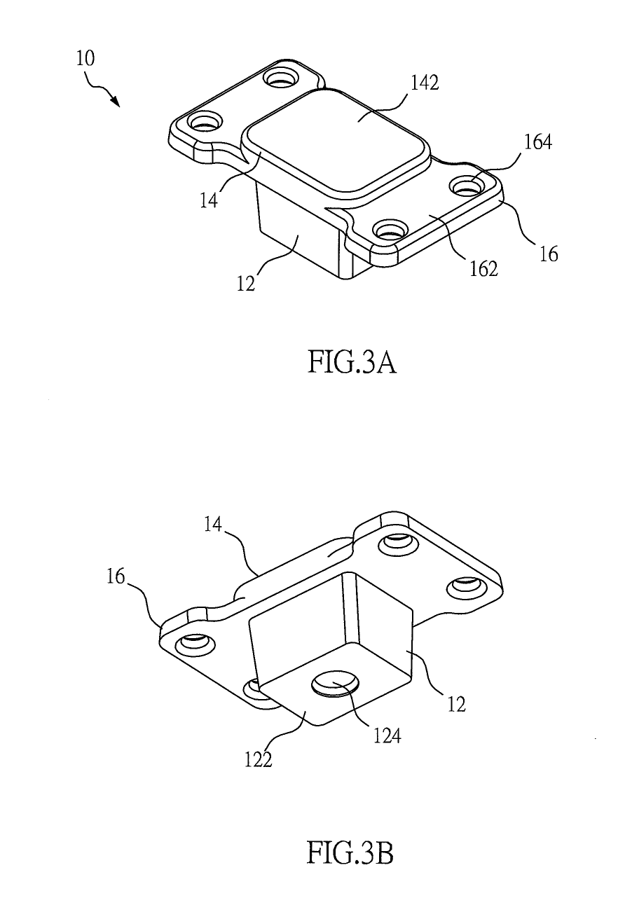

With reference to FIG. 3A and FIG. 3B, FIG. 3A and FIG. 3B are a schematic diagram and a schematic bottom view of an embodiment of the light guide element of the present invention respectively. Please also refer to FIG. 1 and FIG. 2. According to one embodiment of the present invention, the light guide element 10 includes a lower side structure 12, an upper side structure 14 and a central structure 16. The lower side structure 12, having a column shape and extending toward the light emitting element 30 located on the substrate 20, substantially is directly above the light emitting element 30. The bottom portion of the lower side structure 12 includes an incoming light surface 122 which is adjacent to the light emitting element 30 and is the entrance for the emitted light of the light emitting element 30. The preferable distance between the incoming light surface 122 and the light emitting element 30 is about 0.5 millimeter (mm). The upper side structure 14 has a cube shape and its top portion has an outgoing light surface 142, which is adjacent to the lid body 40 and is the exit for the light emitted from the light emitting element 30. The central structure 16 is positioned between the upper side structure 14 and the lower side structure 12, and includes two combining parts 162 extending to both sides respectively. Both combining parts 162 are provided with at least one connecting hole 164 thereon respectively. By joining the connecting hole 164 and the combining bolt on the inner side of the lid body 40, the light guide element 10 is fixed inside the lid body 40.

According to one embodiment of the present invention, as illustrated in FIG. 3A, the shape of the outgoing light surface 142 is preferably but not limited to, for example, rectangular and can be a circular shape, for instance. As shown in FIG. 3B, the shape of the incoming light surface 122 is preferably but not limited to, for example, rectangular and can be a circular shape, for instance. According to one embodiment of the present invention, as shown in FIG. 3B, the incoming light surface 122 also has a recessed hole 124 wherein the position of the recessed hole 124 is corresponding to the position of the light emitting element 30. The recessed hole 124 can provide functions similar to a concave lens to uniformly diverge and scatter light throughout the indicator panel 60.

According to one embodiment of the present invention, as illustrated in FIG. 3B, the cross-sectional area of the lower side structure 12 reduces gradually from the junction of the lower side structure 12 and the central structure 16 downward to the incoming light surface 122 where the cross-sectional area of the lower side structure reaches its minimum. However, the present invention is not limited to those described above. The cross-sectional area of the lower side structure 12 can also increase gradually from the junction of the lower side structure 12 and the central structure 16 downward to the incoming light surface 122 where the cross-sectional area of the lower side structure reaches its maximum. The use of aforementioned various designs can guide light of the light emitting element 30 to reach the lid body 40 and then to pass through the photic zone 62 of the indicator panel 60, enhance the brightness of the light, and uniformly diverge and scatter light throughout the indicator panel 60.

In summary, the objective, method, and efficacy of the present invention are significantly different from the technical features of the prior art. The evaluations, reviews and approval by the Patent Committees of the present invention are greatly appreciated, thus to allow the society to benefit from the present invention. Please be reminded that the embodiments stated above are for purposes of explanation, and numerous specific details are set forth in order to provide a thorough understanding of the disclosed embodiments. Accordingly, the scope of the present invention and claims thereof are defined by the appended claims rather than the foregoing descriptions and the exemplary embodiments described therein.

What is claimed is:

1. A light guide element, which is used to guide light of the light emitting element coming through from a lid body, the light guide element comprising:
a lower side structure, extending toward the light emitting element wherein the bottom portion of the lower side structure has an incoming light surface, and the incoming light surface is adjacent to the light emitting element;
an upper side structure, the upper side structure has an outgoing light surface, the upper side structure being adjacent to the lid body; and
a central structure which is positioned between the upper side structure and the lower side structure wherein the central structure comprises two combining parts extending to both sides of the upper side structure separately and each of the two combining parts has at least one connecting hole respectively whereas the light guide element is joined to the lid body by means of the at least one connecting hole.

2. The light guide element as claimed in claim 1, wherein the shape of the outgoing light surface has one of a circular shape and a rectangular shape.

3. The light guide element as claimed in claim 2, wherein the shape of the incoming light surface has one of a circular shape and a rectangular shape.

4. The light guide element as claimed in claim 3, wherein the incoming light surface has a recessed hole and the position of the recessed hole is corresponding to the position of the light emitting element.

5. The light guide element as claimed in claim 4, wherein the cross-sectional area of the lower side structure reduces gradually from the junction of the lower side structure and the central structure downward to the incoming light surface where the cross-sectional area of the lower side structure reaches its minimum.

6. The light guide element as claimed in claim 5, wherein the cross-sectional area of the lower side structure increases gradually from the junction of the lower side structure and the central structure downward to the incoming light surface where the cross-sectional area of the lower side structure reaches its maximum.

7. An optical device, comprising:
a substrate;
a light emitting element, disposed on the substrate;
a lid body, coupled to the substrate and having a receiving groove on the surface;
a light guide element, coupled to the inner side of the lid body and is substantially disposed above the light emitting element;
a support pad, wherein the underside of the support pad is affixed to the receiving groove; and
an indicator panel, wherein the underside of the indicator panel is affixed to the surface of the support pad whereas the indicator panel has at least one photic zone where light, emitted from the light emitting element and guided by the light guide element, passes through at least one photic zone.

8. The optical device as claimed in claim 7, wherein the support pad is a rubber pad.

9. The optical device as claimed in claim 8, wherein the center of the support pad is hollow.

10. The optical device as claimed in claim 7, wherein the light emitting element is a vertical light emitting diode.

11. The optical device as claimed in claim 7, wherein the shape of at least one photic zone is circular, polygonal, or irregular.

12. The optical device as claimed in claim 7, wherein the light guide element comprises:
an upper side structure, the upper side structure having an outgoing light surface, and the outgoing light surface being adjacent to the lid body;
a lower side structure extending toward the light emitting element, wherein the bottom portion of the lower side structure has an incoming light surface, the incoming light being adjacent to the light emitting element; and
a central structure, positioned between the upper side structure and the lower side structure, wherein the central structure comprises two combining parts extending to both sides of the upper side structure separately; each of the two combining parts has at least one connecting hole respectively; and the light guide element is joined to the lid body by means of the at least one connecting hole.
